(19) United States
(12) Patent Application Publication
(10) Pub. No.: US 2009/0034058 A1
(43) Pub. Date: Feb. 5, 2009

(54) REDUCED THRESHOLD LASER DEVICE

(76) Inventor: Thierry Georges, Perros-Guirec (FR)

Correspondence Address: GREER, BURNS & CRAIN, 300 S WACKER DR, 25TH FLOOR, CHICAGO, IL, 60606, US

(21) Appl. No.: 12/159,729

(22) PCT Filed: Jan. 4, 2007
(86) PCT No.: PCT/FR2007/000005

§ 371 Date: Oct. 7, 2008

(30) Foreign Application Priority Data
Jan. 4, 2006 (FR) 0600064

(51) Int. Cl. H01S 3/00; H01S 3/14; H01S 3/09

(52) U.S. Cl. 359/337.2; 359/337; 359/337.3; 359/342

(57) ABSTRACT

A laser device including: a first amplifying medium capable of emitting a first output laser beam at the output wavelength λs; and a second amplifying medium capable of emitting a second laser beam of intermediate wavelength λi and capable of being pumped at a pump wavelength λp such that λi is included between λp and λs; wherein a single laser cavity containing said first and second amplifying media, this cavity being closed by two mirrors with maximum reflection at the wavelength λi, and in that there are two distinct laser wavelengths λi and λs which take place in said cavity.

The present invention relates to a laser device. It is used particularly beneficially, but not exclusively, in effective three-level transition pumping, the low transition level corresponding to the ground state.

In general, a 3-level laser is a laser for which the low level of the laser transition is the ground level. The medium amplifies only when more than half of the ions are in the excited state.

The local pump power necessary to achieve this level of excitation is

P=hvₚAₚ/νₐₚτ,

where hvₚ is the energy of a pump photon, Aₚ is the area of the transverse extent of the pump, σₐₚ is the effective absorption cross-section of the pump and τ is the excited state lifetime. The single-emitter diodes focus on areas of a few 10⁻⁸ m², which produces values of P of the order of a few W to a few tens of W for the majority of the rare earths in trivalent form in the majority of host materials. In general, the laser threshold is greater than P. This explains why very few diode-pumped three-level lasers have been produced.

The reality is a little more complex as levels are often multiple and slightly separated as regards energy. Each of the sub-levels is thermally populated and is in general at Boltzmann equilibrium. The effective cross-sections are the absolute effective cross-sections multiplied by the relative population of the sub-level. Thus the effective emission and absorption cross-sections differ σₐ≠σₑ. When the low level of the transition is a high-energy sub-level, σₐ<<σₑ and the laser operation approaches that of a 4-level laser. This is the case for example with the 946 nm transition of Nd:YAG (⁴F_{3/2}→⁴I_{9/2}). On the other hand, no experiment is known for example demonstrating the emission around 875 nm corresponding to the ground sub-level of the level ⁴I_{9/2}, this transition corresponding to the 3-level laser.

In particular, trivalent Ytterbium (Yb) has two levels. The ground level ²F_{7/2} has 4 sub-levels. The excited level ⁴F_{5/2}

has 3. In general, the largest effective absorption cross-section corresponds to the transition between the lowest two sub-levels. This transition is that of the 3-level laser (around 980 nm) and it cannot therefore be used for pumping this same 3-level laser. This means that gap is low and that the laser threshold is therefore inevitably high. This is the reason why very few experiments have demonstrated the operation of the 3-level Yb laser for example.

By way of example, only two noteworthy experiments have demonstrated lasers based on the 3-level transition of Ytterbium.

The first experiment relates to a Yb-doped fibre laser, pumped by diodes emitting 18W at 915 nm. This is the only laser exceeding 1 W of output power at 977 nm. This type of laser is described in the publication: “A 3.5-W 977-nm cladding-pumped jacketed air-clad Ytterbium-doped fiber laser”, K. H. Yla-Jarkko, R. Selvas, D. B. S. Soh, J. K. Sahu, C A. Codemard, J. Nilsson, S. U. Alam, and A. B. Grudinin. In, Zayhowski, J J. (ed.) Advanced Sold-State Photonics 2003. Washington D.C., USA, Optical Society of America Trends in Optics and Photonics Series (OSA TOPS Vol 83).

In this document, the reduction of the threshold is achieved by means of the guide structure of a fibre and by means of a high-brilliance diode which make it possible to reduce the pumped area A by a factor greater than 10. The pump injection efficiency is not however good in such fibre lasers. The industrial production of such a laser would require a fibre with polarization maintenance. Finally, a laser power of less than 10 W does not for example allow good frequency-doubling efficiency with conventional non-linear crystals and the conversion yield between the pump and the blue emission (at 488 nm) is low.

The second experiment relates to a Yb:S-FAP laser emitting 250 mW at 985 nm. This laser is described in the article “Efficient laser operation of an Yb: S-FAP crystal at 985 nm”, S. Yiou, F. Balembois, K. Schaffers and P. Georges, Appl. Opt. 42, 4883-4886 (2003). It is pumped by a Ti:sapphire laser emitting 1.45 W at 900 nm.

The reduction of the threshold is obtained by the choice of a material (S-FAP) maximizing the product σₐₚτ and by laser pumping, which makes it possible to reduce the pumped area A by a factor at least 10.

The main difficulties of Yb lasers emitting at around 980 nm are twofold. The first is the gain competition between 4-level emissions and the 3-level emission. In order to reduce the maximum gain of the 4-level emissions to the threshold of the 3-level emission, the product of Ytterbium concentration N and the length L should be reduced. The other difficulty arises from the small size of the effective absorption cross-sections of the pump (between 900 and 950 nm) and the inadequacy of the largest absorption wavelength with available semiconductor sources. The combination of a low NL product and a small effective absorption cross-section of the pump induces a reduced absorption of the pump in the laser. This therefore reduces the efficiency of the laser.

The choice of the Yb:S-FAP crystals was made as a function of the high value of the effective absorption cross-section of the Yb in the S-FAP. The two major problems arise from the lack of S-FAP suppliers and from the pump wavelength (899 nm) which does not correspond to commercial diodes. The other known crystals are less favourable.

The objective of the present invention is to remedy the abovementioned drawbacks, and in particular to reduce the emission threshold of a 3-level laser. Another purpose of the invention is to design a 3-level laser which can be excited by an extended range of wavelengths. A further purpose of the present invention is to provide a highly effective compact laser. A final purpose of the invention is to design a diode-pumped laser for which the excitation of the amplifying medium cannot be carried out by direct pumping by a pump diode (due to non-availability of the wavelength or lack of spatial adaptation of the pump mode).

At least one of the abovementioned objectives is achieved with a laser device comprising:
a first amplifying medium capable of emitting a first output laser beam at the output wavelength λs;
a second amplifying medium capable of emitting a second laser beam of intermediate wavelength λi and capable of being pumped at a pump wavelength λp such that λi is comprised between λp and λs;
a single laser cavity containing said first and second amplifying media, this cavity being closed by two mirrors with maximum reflection at the wavelength λi.

With the device according to the invention, the laser emission of the second amplifying medium is used for pumping the first amplifying medium inside a single laser cavity. The present invention thus makes it possible to extend the range of pump wavelengths used in order to allow the first amplifying medium to lase. In other words, it is thus possible to pump any amplifying medium which generally does not effectively absorb the wavelengths emitted by the diodes.

Advantageously, the first amplifying medium can be a three-level amplifying medium. The present invention in particular makes it possible to considerably reduce the laser emission threshold and at the same time to increase the efficiency of three-level lasers. In particular, there are two distinct laser wavelengths λi and λs which take place in said cavity.

According to an advantageous characteristic of the invention, the first amplifying medium comprises an active element absorbing the laser beam at the intermediate wavelength λi. In particular, this absorption of the laser beam at the intermediate wavelength λi in the first amplifying medium is greater than the non-resonant losses of this laser beam at the intermediate wavelength λi.

In order to obtain the advantageous components of the present invention, the procedure described hereafter was followed.

Beyond the laser threshold, the equation linking the pump power Pₚᵢ the laser power P₁ and the fraction x of excited ions can be approximated by:

$$\frac{{AN}_{1} {L}_{1} {x}_{1}}{{τ}_{1}} + \frac{{P}_{1}}{{hv}_{1}} ( {G}^{2} - 1 ) = \frac{{P}_{p}}{{hv}_{p}} ( 1 - exp ( - {α}_{p 1} ( {x}_{1} ) {L}_{1} ) ) \qquad ( 1 )$$

Where A is the cross-section of the pump, N₁ is the concentration of doping ions, L₁ is the length of the amplifying medium, τ₁ is the excited state lifetime, G is the gain exactly compensating for the losses η of the laser cavity and αₚ₁(x₁)=σₐₚ₁N₁L₁(1−Γx₁) is the linear absorption coefficient of the pump as a function of the population inversion, Γ is the overlap factor of the pump over the transverse distribution of excited ions. The value of x is given by the solution of G²(x₁)η=1. The threshold is the value of Pₚ, solution of (1) when P₁=O.

For a true 3-level laser, X₁ is of the order of 0.5 or more, whereas for a 4-level laser, the value of x can be as low as 0.01. In order to reduce the laser threshold (linked to the left part of the equation), the product N₁L₁ should be minimized. On the other hand, a good transfer of the pump power to the laser requires that αₚₜ(x₁)L₁>>1. If the effective absorption cross-section σₐₚ₁ is small, this means that the product N₁L₁ must be large.

In order to resolve the problem of the threshold and that of the transfer of pump power to the laser, a novel laser design according to the present invention is therefore proposed. It is proposed to add a second amplifying medium of concentration N₂, of length L₂, of its excited state lifetime Γ₂ absorbing the pump wavelength λp and having gain at an intermediate wavelength λi between the pump wavelength and the laser wavelength λs. The wavelength λi is absorbed by the first amplifying medium. The mirrors are highly reflective at the wavelength λi so as to minimize the non-resonant losses η₂ of the laser λi. These losses can be well below 1%. If the absorption of the first amplifying medium is well above η₂ (this is true from a few % of absorption), the equation of the novel laser is approximated by

$$\frac{{AN}_{1} {L}_{1} {x}_{1}}{{τ}_{1}} + \frac{{AN}_{2} {L}_{2} {x}_{2}}{{τ}_{2}} + \frac{{P}_{1}}{{hv}_{1}} ( {G}^{2} - 1 ) = \frac{{P}_{p}}{{hv}_{p}} ( 1 - exp ( - {α}_{p 2} ( {x}_{2} ) {L}_{2} ) ) \qquad ( 2 )$$

The fraction x₂ of excited ions of the first amplifying medium is that which allows the laser threshold at the wavelength λi. If the second amplification medium is well chosen, the value of x₂ can be fairly low <0.1).

The use of the second amplifying medium in general makes it possible to reduce by a factor of 10 the value of the product N₁L₁ while increasing the absorption level of the pump. It is sufficient that the term AN₂L₂x₂/τ₂ is sufficiently low compared with AN₁L₁x₁/τ₁ in order to significantly reduce the laser threshold.

According to an advantageous embodiment of the present invention, the cavity is of monolithic resonant linear type, and the different elements can be in contact optically.

Preferably, the emission threshold of the second amplifying medium at the wavelength λi is below the emission threshold of the first amplifying medium at the wavelength λs when the latter is pumped directly.

By way of example, the first amplifying medium is based on the three-level transition of trivalent Ytterbium with an output wavelength of around 980 nm. This Ytterbium can be contained in a silicate matrix doped with Ytterbium (Yb).

The second amplifying medium can be based on the ⁴F_{3/2}→⁴I_{9/2} transition of trivalent neodymium Nd, the latter being able to be contained in a matrix of a material from the following list: YAG; YVO₄; GdVO₄; YAP or YLF.

According to an advantageous characteristic, it is possible to insert into the cavity according to the present invention, elements such as a polarizer, a filter, a non-linear crystal or any other element suitable for being inserted into a laser cavity.

In particular, the device according to the present invention can be such that the first amplifying medium comprises Ytterbium emitting at around 980 nm. Moreover, it is possible to use an intra-cavity frequency-doubling non-linear crystal. In this case, the wavelength emitted by the laser device is half that of the first amplifying medium.

Other advantages and characteristics of the invention will become apparent upon examination of the detailed description of an embodiment which is in no way limitative, and the attached drawings, in which:

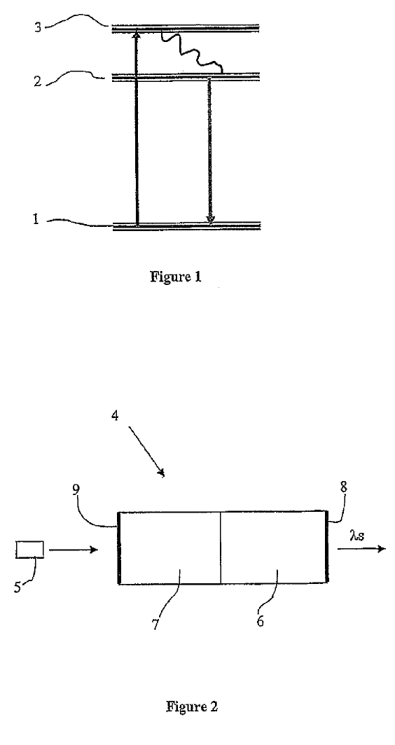

FIG. 1 is a simplified diagram of a three-level laser;

FIG. 2 is a simplified diagram of a laser device according to the present invention, pumped by a laser diode;

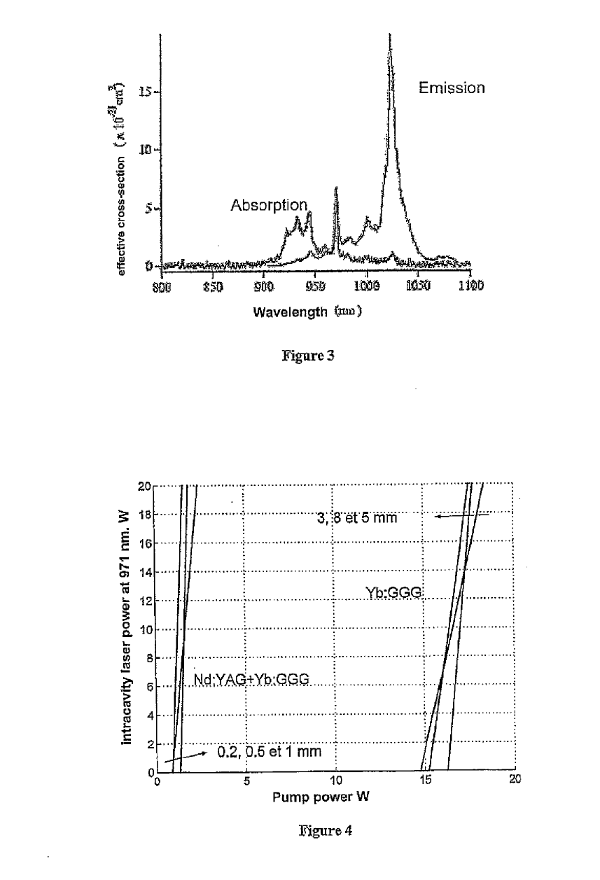

FIG. 3 is a graphical representation of the curves of the effective absorption and emission cross-sections of Ytterbium in a GGG matrix;

FIG. 4 is a graph representing the characteristics of a conventional laser and of a laser according to the present invention;

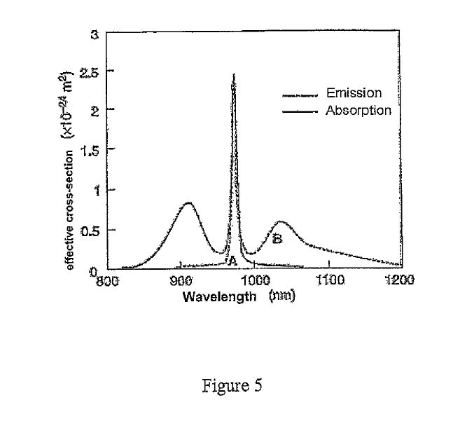

FIG. 5 is a graphical representation of the curves of the effective absorption and emission cross-sections of Ytterbium in a silica matrix.

FIG. 1 shows a representation of the energy states of a three-level laser. Three states can be distinguished, state 1: ground energy level, state 2: excited energy level, and state 3: pump absorption energy level. Each transition from one state to another is associated with a physical phenomenon. The passage from state 1 to state 3 occurs by optical pumping with absorption of photons. The passage from state 3 to state 2 occurs by relaxation of atoms, i.e. a generally non-radiative and rapid de-excitation. The atoms remain in state 2 for a period of time equal to a given lifetime. The passage from state 2 to state 1 occurs by the emission of photons forming the laser beam.

FIG. 2 shows a laser device 4 according to the present invention, pumped by a laser diode 5. This laser device 4 is composed of two amplifying media 6 and 7 forming a monolithic linear cavity. The laser beam emitted by the laser diode 5 is co-linear with the laser device 4.

The first amplifying medium 6 is an active three-level medium, arranged downstream of a second amplifying medium 7, the order being able to be reversed. The emission wavelength λi of the latter is comprised between the emission wavelength λp of the pump 5 and the emission wavelength λs of the first amplifying medium. The second amplifying medium is excited by the pump 5. The laser cavity of the device comprises a mirror 8 with maximum reflection Rmax at the wavelength λi, this mirror being joined to the output surface of the first amplifying medium 6. The laser cavity of the device also comprises a mirror 9 with maximum reflection Rmax at the wavelength λi, this mirror being joined to the input surface of the second amplifying medium 7.

FIGS. 3 to 5 make it possible to highlight the advantages procured by the present invention when applied to a three-level Ytterbium Yb laser emitting at around 980 nm.

Yb:YAG crystals are frequently used for an emission at 1031 nm (4-level laser). In the YAG matrix, the Yb ion has a 3-level transition at the wavelength of 968 nm. Unfortunately, at this wavelength σₐ₁=7.10⁻²⁵m²>σₑ₁=3.10⁻²⁵m². This means that the threshold of the emission laser requires excitation of more than 70% of the ions. In order to overcome this problem, a slightly different crystalline matrix (GGG) is chosen. The characteristics of Yb:GGG are as follows: the 3-level emission peak is 971 nm and the 4-level emission peak is 1031 nm, the absorption bandwidth is 930-945 nm, σₐ₁(971)=6.6.10⁻²⁵m², σₐ₁(940)=4.10⁻²⁵m²,τ=0.8 ms. The effective absorption and emission cross-sections are shown in FIG. 3. That is to say a crystal doped with 2% Yb (N_{y}=2.5.10²⁶m⁻³). It is assumed

that the pump is uniform over a diameter of 150 μm. If there is interest in intra-cavity frequency-doubling for example, a cavity with Rmax mirrors is considered and the laser power at 971 nm is calculated assuming that the round-trip losses are equal to 2%. The simulations show that a length of crystal L_{y}=5 mm is close to the optimum. Beyond this value, the laser threshold becomes really high and the 4-level laser gain becomes so great that it is difficult to prevent it from oscillating. Below this length, the pump is no longer absorbed effectively. The laser threshold is 15 W for the length of 5 mm. The laser power reaches 20 W for a pump power of 17.5 W (see the curves on the right in FIG. 4).

The efficiency of the present invention is demonstrated by using Nd:YAG as second gain medium. A crystal doped at 1.1% with Nd (N_{N}=1.53. 10²⁶m⁻³) and with a thickness L_{N}=2 mm is considered. The Nd ion is pumped at 808 nm and can emit at a wavelength of 946 nm. The excited state lifetime is τ=0.19 ms and σₐ₂(808)=6.15.10⁻²⁴m², σₑ₂(946)=3.9.10⁻²⁴m², σₐ₂(946)=4.5.10⁻²⁶m². As discussed previously, it is possible to greatly reduce the thickness of Yb:GGG to L_{y}=0.5 mm for example. With these values, the laser threshold is below 0.9 W and the laser power at 971 nm reaches 20 W for a pump power of 1.55 W in conformity with the curves on the left in FIG. 4.

It has thus been demonstrated with the present invention that it is possible to greatly reduce the threshold of the 3-level lasers by preserving, or even increasing, the absorption of the pump and therefore the conversion efficiencies. This invention derives all its meaning in particular, but not exclusively, from the production of a laser source around 980 nm or around 490 nm (by inserting a frequency-doubling crystal into the cavity) from the 3-level transition of Yb. The majority of the host materials can be considered, including Yb:SiO₂ (FIG. 5) which has the advantage of emitting at 976 nm. The double frequency corresponds exactly to the main wavelength of Argon lasers (488 nm).

In a general fashion, the present invention allows effective pumping of a 3-level laser. In order to do this, a second laser medium, which can be excited with a pump of

wavelength λp has been introduced into the laser cavity; this second medium emitting an intermediate wavelength λi, comprised between the pump wavelength and that of the 3-level laser λs. It is also ensured that the mirrors of the laser cavity are Rmax (maximum reflection) at the wavelength λi. Preferably, the laser threshold λi is lower than that of the laser λs when the latter is pumped directly. Moreover, the wavelength λi is preferably absorbed by the 3-level laser medium and this absorption is greater than the other losses of the cavity. Other elements can be added inside the cavity, such as a polarizer, a filter or non-linear crystals. The present invention is applied in particular to the three-level transition of Yb³⁺, the wavelength of which is situated around 980 nm depending on the host material. This makes it possible to produce lasers emitting at around 980 nm or lasers emitting at around 490 nm when an intra-cavity frequency-doubling device is included.

Of course, the invention is not limited to the examples which have just been described and numerous adjustments can be made to these examples without exceeding the scope of the invention. In fact, the present invention can advantageously be applied to amplifying media other than the three-level amplifying medium, such as for example the four-level amplifying medium.

1. A laser device comprising:
a first amplifying medium capable of emitting a first output laser beam at the output wavelength λs; and
a second amplifying medium capable of emitting a second laser beam of intermediate wavelength λi and capable of being pumped at a pump wavelength λp such that λi is comprised between λp and λs; characterized by a single laser cavity containing said first and second amplifying media, this cavity being closed by two mirrors with maximum reflection at the wavelength λi, and in that there are two distinct laser wavelengths λi and λs which take place in said cavity.

2. The device according to claim 1, wherein said first amplifying medium comprises an active element absorbing the laser beam at the intermediate wavelength λi.

3. The device according to claim 2, wherein said absorption of the laser beam at the intermediate wavelength λi in the first amplifying medium is greater than the non-resonant losses of this laser beam at the intermediate wavelength λi.

4. The device according to claim 1, wherein said cavity is of monolithic resonant linear type.

5. The device according to claim 1, wherein said emission threshold of the second amplifying medium at the wavelength λi is below the emission threshold of the first amplifying medium at the wavelength λs when the latter is pumped directly.

6. The device according to claim 1, wherein said first amplifying medium is based on the three-level transition of trivalent Ytterbium.

7. The device according to claim 1, wherein said first amplifying medium comprises a silicate matrix doped with Ytterbium (Yb).

8. The device according to claim 1, wherein said second amplifying medium is based on the ⁴F_{3/2}→⁴I_{9/2} transition of trivalent neodymium Nd.

9. The device according to claim 8, wherein said trivalent Nd is contained in a matrix of a material from the following list: YAG; YVO₄; GdVO₄; YAP or YLF.

10. The device according to claim 1, wherein said cavity also comprises a polarizer.

11. The device according to claim 1, wherein said cavity also comprises a filter.

12. The device according to claim 1, wherein said cavity also comprises a non-linear crystal.

13. The device according to claim 12, characterized in that the first amplifying medium comprises Ytterbium emitting at around 980 nm, and in that it also comprises an intra-cavity non-linear frequency-doubling crystal.
